(19) United States
(12) Patent Application Publication
(10) Pub. No.: US 2011/0088841 A1
(43) Pub. Date: Apr. 21, 2011

(54) APPARATUS AND METHOD OF IMPREGNATING FIBROUS WEBS

(76) Inventors: Kristin L. Thunhorst, Stillwater, MN (US); Mikhail L. Pekurovsky, Bloomington, MN (US)

(21) Appl. No.: 12/666,905

(22) PCT Filed: Jun. 27, 2008
(86) PCT No.: PCT/US2008/068466

§ 371 Date: Dec. 3, 2010

Related U.S. Application Data
(60) Provisional application No. 60/947,785, filed on Jul. 3, 2007.
(60) Provisional application No. 60/947,798, filed on Jul. 3, 2007.

(51) Int. Cl. B05C 3/172; B05D 3/12; C09J 5/02

(52) U.S. Cl. 156/307.5; 118/428; 427/346

(57) ABSTRACT

The present disclosure relates to an apparatus and method of impregnating fibrous webs. An apparatus generally includes a volume of liquid curable resin having a liquid surface, and a liquid curable resin (310) saturated roll of fibrous web (320) at least partially submerged in the volume of resin. The apparatus is configured to unwind the liquid curable resin saturated roll of fibrous web such that the fibrous web separates from the roll of fibrous web below the liquid surface and forms a resin impregnated fibrous web.

### FIELD

The present disclosure relates to an apparatus and method of impregnating fibrous webs.

### BACKGROUND

Impregnation of fibrous webs have application in a number of industries includes, for example, aerospace, automotive, boatbuilding, and display manufacturing. One purpose of impregnating a fibrous web with a polymeric resin is to from a composite structure that has beneficial properties of each of its components. For example, a fiberglass cloth impregnated with a resin has mechanical extensional properties to that of fiberglass and mechanical bending properties similar to that of resin. In some cases the resulting composite film should have a minimal number of defects.

Most fibrous webs have two scales associated with inter-fibril separation. In fiberglass fabric, for example, scale of inter-yarn separation is on the order of fractional millimeters, while the scale of inter-fiber separation in a yarn is smaller, and on the order of micrometers. In general, resin can be infused into a fibrous web by action of either externally imposed pressure gradient or capillary force. During infusion, air, possibly rarified by applied low pressure, or another gas has to be displaced from inter-yarn and inter-fibril spaces. If during impregnation a number of gas bubbles are entrapped, some of the gas bubbles can be removed by generating a flow of resin through the thickness of the fibrous material. Smaller bubbles can dissolve over time, if the impregnating resin is left to be a liquid for a sufficient time.

Dependent on their level, entrapped air bubbles remaining after the resin is reacted (i.e., cured) to form a solid, can reduce the mechanical and optical properties of a resin impregnated fibrous web.

### BRIEF SUMMARY

The present disclosure relates to an apparatus and method of impregnating fibrous webs. The apparatus generally includes a volume of liquid curable resin having a liquid surface, and a liquid curable resin saturated roll of fibrous web at least partially submerged in the volume of resin. The apparatus is configured to unwind the liquid curable resin saturated roll of fibrous web such that the fibrous web separates from the liquid curable resin saturated roll of fibrous web below the liquid surface and forms a resin impregnated fibrous web. In many embodiments, the temperatures of the liquid curable resin and the fibrous web can be manipulated independently (for example, heated or cooled) before they are combined, as desired.

In a first embodiment, an apparatus includes a volume of liquid curable resin being solvent free and having a liquid surface, and a liquid curable resin saturated roll of fibrous web at least partially submerged in the volume of resin. The apparatus is configured to unwind the liquid curable resin saturated roll of fibrous web such that the fibrous web separates from the roll of fibrous web below the liquid surface and forms a resin impregnated fibrous web.

In another embodiment, an apparatus includes a volume of liquid curable resin having a liquid surface, and a liquid curable resin saturated roll of fibrous web partially submerged in the volume of resin. The apparatus is configured to unwind the liquid curable resin saturated roll of fibrous web such that the fibrous web separates from the roll of fibrous web below the liquid surface and forms a resin impregnated fibrous web and a portion of the roll of fibrous web being disposed above the liquid surface.

In a further embodiment, a method of impregnating a fibrous web includes disposing a liquid curable resin saturated roll of fibrous web at least partially in a volume of liquid curable resin being solvent free and having a liquid surface, unwinding the liquid curable resin saturated roll of fibrous web such that the fibrous web separates from the roll of fibrous web below the liquid surface and forms a resin impregnated fibrous web, and curing the resin impregnated fibrous web to form a cured resin impregnated fibrous web.

In another embodiment, a method of impregnating a fibrous web includes disposing a liquid curable resin saturated roll of fibrous web partially in a volume of liquid curable resin being solvent free and having a liquid surface and a portion of the liquid curable resin saturated roll of fibrous web being disposed above the liquid surface, unwinding the liquid curable resin saturated roll of fibrous web such that the fibrous web separates from the roll of fibrous web below the liquid surface and forms a resin impregnated fibrous web, and curing the resin impregnated fibrous web to form a cured resin impregnated fibrous web

In a further embodiment, a method of impregnating a fibrous web includes saturating a roll of fibrous web with a liquid curable resin to form a liquid curable resin saturated roll of fibrous web, unwinding the liquid curable resin saturated roll of fibrous web such that the fibrous web separates from the liquid curable resin saturated roll of fibrous web and forms a resin impregnated fibrous web, curing the resin impregnated fibrous web to form a cured resin impregnated fibrous web.

### BRIEF DESCRIPTION OF THE DRAWINGS

The disclosure may be more completely understood in consideration of the following detailed description of various embodiments of the disclosure in connection with the accompanying drawings, in which:

FIG. 1 is a schematic perspective side view of an illustrative resin impregnated fibrous web;

FIG. 2 is an schematic top view of an illustrative fibrous web;

FIG. 3 is a schematic side view of an illustrative apparatus for forming a resin impregnated fibrous web;

FIG. 4 is a schematic side view of an illustrative apparatus for processing a resin impregnated fibrous web;

FIG. 5 is a schematic side view of another illustrative apparatus for processing a resin impregnated fibrous web;

FIG. 6 is a schematic side view of an illustrative apparatus for forming a resin impregnated pre-saturated fibrous web; and

FIG. 7 is a schematic side view of an illustrative apparatus for processing a resin impregnated pre-saturated fibrous web.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

In the following description, reference is made to the accompanying drawings that form a part hereof, and in which are shown by way of illustration several specific embodiments. It is to be understood that other embodiments are contemplated and may be made without departing from the scope or spirit of the present invention. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

The present disclosure relates to an apparatus and method of resin impregnating fibrous webs. This disclosure utilizes capillary forces to resin impregnate fibrous webs to achieve bubble-free composites. Interaction of the resin and fibrous web is organized in such a way that resin translates through the thickness of the fibrous web only by action of capillary force with minimal imposed external pressure gradient. Sometimes this translation of resin through the thickness direction (z-direction in FIG. 2) through the fabric is referred to as out-of-plane wicking. The minimum (smallest or lowest frequency) amount of bubbles possible are experienced through this out-of-plane wicking-type saturation. In the cases where out-of-plane wicking saturation still results in fibrous webs containing bubbles, generally the bubbles will be smaller than those produced by other techniques, and are, thus, easier to subsequently dissolve into the resin material. In one embodiment, a roll of fibrous web is at least partially submerged in a volume of resin (that can be solvent-free) and as the fibrous web is unwound from the roll, resin is brought on the top of the advancing/unwinding roll allowing capillary action to wick resin through the thickness of the roll (out-of-plane wicking). In another embodiment, a roll of fibrous web is saturated with resin prior to at least partially submerging the roll of fibrous web in the volume of resin. The saturated roll is then unwound in the volume of resin and processed to make a composite bubble-free film. The layer of liquid curable resin brought on top of the unwinding roll of fibrous web can be applied to the outside of the roll either through the natural action of the rotation of the roll, and/or through intentional addition of resin by some mechanism such as a coating device. This coating device could include, but is not limited to, die coating, roll coating, and the like

In some cases, it is advantageous to manipulate the viscosity of the liquid curable resin as it permeates the fibrous web. In these situations, the temperature of either the liquid curable resin and the fibrous web, or both, can be independently manipulated to modify the viscosity of the liquid curable resin. For example, the lowest viscosity of the liquid curable resin will be experienced when both the fibrous web and the liquid curable resin are at elevated temperatures prior to combining them. While the present invention is not so limited, an appreciation of various aspects of the invention will be gained through a discussion of the examples provided below.

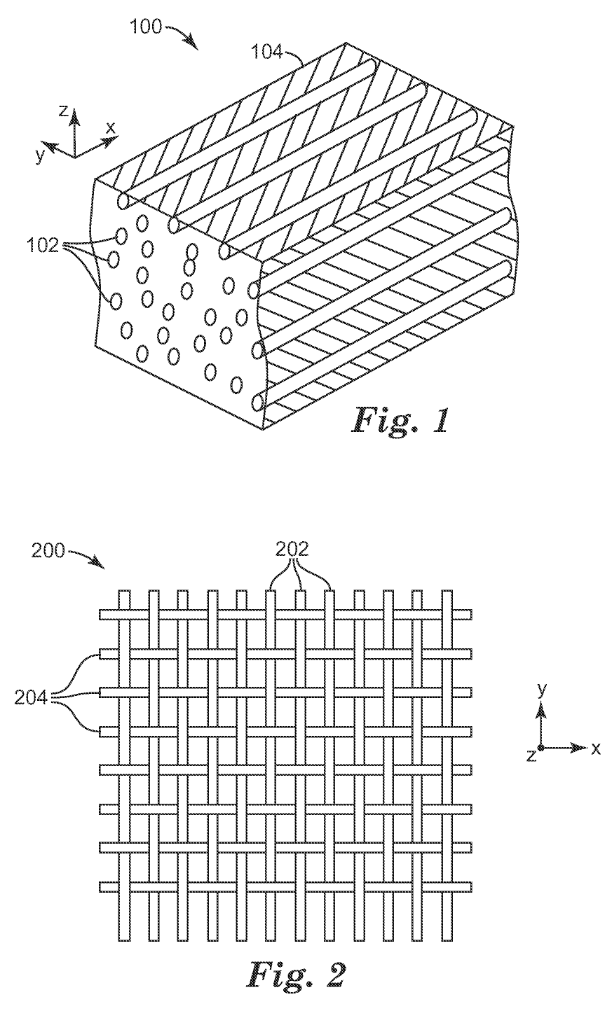

FIG. 1 is a schematic perspective side view of an illustrative resin impregnated fibrous web 100 showing the resin impregnated fibrous web 100 relative to an arbitrarily assigned coordinate system. The resin impregnated fibrous web 100 has a thickness in the z-direction. The resin impregnated fibrous web includes reinforcing fibers 102 within a polymer or resin matrix 104. The resin impregnated fibrous web 100 is formed as a bulk element, and may, for example be in the form of a sheet or film, a cylinder, a tube or the like.

Reinforcing fibers 102, such as organic fibers of resin, or inorganic fibers of glass, glass-ceramic or ceramic, are disposed within the matrix 104. Individual reinforcing fibers 102 may extend throughout the length of the resin impregnated fibrous web 100, although this is not a requirement. In the illustrated embodiment, the fibers 102 are lengthwise oriented parallel to the x-direction, although this need not be the case. The fibers 102 may be organized within the matrix 104 as a web of reinforcing fibers, as described below.

In some embodiments, the reinforcing fibers 102 assist in forming a polarizing film as described in U.S. Patent Application Publication No. 2006/0193577, which is incorporated by reference herein to the extent it does not conflict with the current disclosure.

The refractive indices in the x-, y-, and z-directions for the material forming the resin matrix 104 are referred to herein as n₁ₓ, n_{1y} and n_{1z}. Where the resin material is isotropic, the x-, y-, and z-refractive indices are all substantially matched. Where the matrix material is birefringent, at least one of the x-, y- and z-refractive indices is different from the others. In some cases, only one refractive index is different from the others, in which case the material is called uniaxial, and in others all three refractive indices are different, in which case the material is called biaxial. In many embodiments, the material of the fibers 102 is isotropic. Accordingly, the refractive index of the material forming the fibers is given as n₂. In some embodiments, the reinforcing fibers 102 are birefringent.

In some embodiments, it may be desired that the resin matrix 104 be isotropic, i.e., n₁ₓ≈n_{1y}≈n_{1z}. To be considered isotropic, the differences among the refractive indices should be less than 0.05, preferably less than 0.02 and more preferably less than 0.01. Furthermore, in some embodiments it is desirable that the refractive indices of the matrix 104 and the fibers 102 be substantially matched. Thus, the refractive index difference between the matrix 104 and the fibers 102, should be small, at least less than 0.03, or less than 0.005, or less than 0.002. In other embodiments, it may be desired that the resin matrix 104 be birefringent, in which case at least one of the matrix refractive indices is different from the refractive index of the fibers 102.

Suitable materials for use in the polymer or resin matrix include thermoplastic and thermosetting polymers that are transparent over the desired range of light wavelengths. In some embodiments, it may be particularly useful that the polymers be non-soluble in water, the polymers may be hydrophobic or may have a low tendency for water absorption. Further, suitable polymer materials may be amorphous or semi-crystalline, and may include homopolymer, copolymer or blends thereof. Example polymer materials include, but are not limited to, poly(carbonate) (PC); syndiotactic and isotactic poly(styrene) (PS); C₁-C₈ alkyl styrenes; alkyl, aromatic, and aliphatic and ring-containing (meth)acrylates, including poly(methylmethacrylate) (PMMA) and PMMA copolymers; ethoxylated and propoxylated(meth)acrylates; multifunctional (meth)acrylates; urethane (meth)acrylates; acrylated epoxies; epoxies; norbornenes; vinyl esters, vinyl ethers, and other ethylenically unsaturated materials; thiol-ene monomer and oligomer systems and unsaturated polyesters; hybrid radical and cationic polymerizable systems such as epoxy and (meth)acrylates, and combinations of these; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends. The term (meth)acrylate is defined as being either the corresponding methacrylate or acrylate compounds.

In some embodiments, it is advantageous to utilize polymeric materials as the reinforcing fibers. Example polymer materials include, but are not limited to, poly(carbonate) (PC); syndiotactic and isotactic poly(styrene) (PS); C₁-C₈ alkyl styrenes; alkyl, aromatic, aliphatic and ring-containing (meth)acrylates, including poly(methylmethacrylate) (PMMA) and PMMA copolymers; ethoxylated and propoxylated(meth)acrylates; multifunctional (meth)acrylates; acrylated epoxies; epoxies; and other ethylenically unsaturated materials; cyclic olefins and cyclic olefinic copolymers; acrylonitrile butadiene styrene (ABS); styrene acrylonitrile copolymers (SAN); epoxies; poly(vinylcyclohexane); PMMA/poly(vinylfluoride) blends; poly(phenylene oxide) alloys; styrenic block copolymers; polyimide; polysulfone; poly(vinyl chloride); poly(dimethyl siloxane) (PDMS); polyurethanes; saturated polyesters; poly(ethylene), including low birefringence polyethylene; poly(propylene) (PP); poly(alkane terephthalates), such as poly(ethylene terephthalate) (PET); poly(alkane napthalates), such as poly(ethylene naphthalate)(PEN); polyamide; ionomers; vinyl acetate/polyethylene copolymers; cellulose acetate; cellulose acetate butyrate; fluoropolymers; poly(styrene)-poly(ethylene) copolymers; PET and PEN copolymers, including polyolefinic PET and PEN; and poly(carbonate)/aliphatic PET blends.

In some product applications, the resulting products and components exhibit low levels of fugitive species (low molecular weight, unreacted, or unconverted molecules, dissolved water molecules, or reaction byproducts). Fugitive species can be absorbed from the end-use environment of the product, e.g. water molecules, can be present in the product from the initial product manufacturing, e.g. water, or can be produced as a result of a chemical reaction (for example a condensation polymerization reaction). An example of small molecule evolution from a condensation polymerization reaction is the liberation of water during the formation of polyamides from the reaction of diamines and diacids. Fugitive species can also include low molecular weight organic materials such as monomers, plasticizers, etc. The fugitive species are generally lower molecular weight than the majority of the material forming the rest of the functional product. Product use conditions might, for example, result in thermal stress that is differentially greater on one side of the product or film. In these cases, the fugitive species can migrate through the product or volatilize from one surface of the film or product causing concentration gradients, gross mechanical deformation, surface alteration and, sometimes, undesirable out-gassing. The out-gassing could lead to voids or bubbles in the product, film or matrix, or problems with adhesion to other films. Fugitive species can, potentially, also solvate, etch or undesirably affect other components in product applications.

Several of the above polymers or resins may become birefringent when oriented. In particular, PET, PEN, and copolymers thereof, and liquid crystal polymers, manifest relatively large values of birefringence when oriented. Resins may be oriented using different methods, including extrusion and stretching. Stretching is a particularly useful method for orienting a polymer, because it permits a high degree of orientation and may be controlled by a number of easily controllable external parameters, such as temperature and stretch ratio.

Suitable curable resins or polymers include ethylenically unsaturated resin and a photoinitiator and/or a thermal initiator and/or a cationic initiator. If the curing is done with e-beam, or with thiol-ene type reactive systems, a separate initiator is not required.

The matrix 104 may be provided with various additives to provide desired properties to the resin impregnated fibrous web 100. For example, the additives may include one or more of the following: an anti-weathering agent, UV absorbers, a hindered amine light stabilizer, an antioxidant, a dispersant, a lubricant, an anti-static agent, a pigment or dye, a nucleating agent, a flame retardant and a blowing agent.

Some exemplary embodiments may use a polymer matrix material that is resistant to yellowing and clouding with age. For example, some materials such as aromatic urethanes become unstable when exposed long-term to UV light, and change color over time. It may be desired to avoid such materials when it is important to maintain the same color long term. Other additives may be provided to the matrix 104 for altering the refractive index of the polymer or increasing the strength of the material. Such additives may include, for example, organic additives such as polymeric beads or particles and polymeric nanoparticles.

In other embodiments, inorganic additives may be added to the matrix 104 to adjust the refractive index of the matrix, or to increase the strength and/or stiffness of the material. For example, the inorganic material may be glass, ceramic, glass-ceramic or a metal-oxide. Any suitable type of glass, ceramic or glass-ceramic, discussed below with respect to the inorganic fibers, may be used. Suitable types of metal oxides include, for example, titania, alumina, tin oxides, antimony oxides, zirconia, silica, mixtures thereof or mixed oxides thereof. These inorganic materials can be provided as nanoparticles, for example milled, powdered, bead, flake or particulate in form, and distributed within the matrix 104. The size of the particles can be less than 200 nm, or less than 100 nm, or less than 50 nm to reduce scattering of the light passing through the final film product.

The surfaces of these inorganic additives may be provided with a coupling agent for binding the inorganic additive to the polymer. For example, a silane coupling agent may be used with an inorganic additive to bind the inorganic additive to the polymer. Although inorganic nanoparticles lacking polymerizable surface modification can be employed, the inorganic nanoparticles may be surface modified such that the nanoparticles are polymerizable with the organic component of the matrix. For example, a reactive group may be attached to the other end of the coupling agent. The group can chemically react, for example, through chemical polymerization via a double bond with the reacting polymer matrix.

FIG. 2 is a schematic top view of an illustrative fibrous web 200. Any suitable type of organic or inorganic material may be used for the reinforcing fiber 102 forming the fibrous web 200. Illustrative fiber forming materials include glass fibers, carbon and/or graphite fibers, polymer fibers, boron fibers, ceramic fibers, glass-ceramic fibers, and silica fibers. In many embodiments, the fibers are formed into a fibrous web 200 as illustrated in FIG. 2.

The fiber 102 may be formed of an inorganic material such as, for example, a glass that is substantially transparent to the light passing through the film. Examples of suitable glasses include glasses often used in fiberglass composites such as E, C, A, S, R, and D glasses. The surfaces of these fibers may be provided with a coupling agent for binding the fiber to the polymer. For example, a silane coupling agent may be used with a fiber to bind the fiber to the matrix resin upon polymerization. Higher quality glass fibers may also be used, including, for example, fibers of fused silica and BK7 glass. Suitable higher quality glasses are available from several suppliers, such as Schott North America Inc., Elmsford, N.Y. It may be desirable to use fibers made of these higher quality glasses because they are purer and so have a more uniform refractive index and have fewer inclusions, which leads to less scattering and increased transmission. Also, the mechanical properties of the fibers are more likely to be uniform. Higher quality glass fibers are less likely to absorb moisture, and thus the resulting film becomes more stable for long term use. Furthermore, it may be desirable to use a low alkali glass, since alkali content in glass increases the absorption of water.

Another type of inorganic material that may be used for the fiber 102 is a glass-ceramic material. Glass-ceramic materials generally include 95%-98% vol. of very small crystals, with a size smaller than 1 micrometer. Some glass-ceramic materials have a crystal size as small as 50 nm, making them effectively transparent at visible wavelengths, since the crystal size is so much smaller than the wavelength of visible light that virtually no scattering takes place. These glass-ceramics can also have very little, or no, effective difference between the refractive index of the glassy and crystalline regions, making them visually transparent. In addition to the transparency, glass-ceramic materials can have a rupture strength exceeding that of glass, and are known to have coefficients of thermal expansion of zero or that are even negative in value. Glass-ceramics of interest have compositions including, but not limited to, Li₂O—Al₂O₃—SiO₂, CaO—Al₂O₃—SiO₂, Li₂O—MgO—ZnO—Al₂O₃—SiO₂, Al₂O₃—SiO₂, and ZnO—Al₂O₃—ZrO₂—SiO₂, Li₂O—Al₂O₃—SiO₂, and MgO—Al₂O₃—SiO₂.

Some ceramics also have crystal sizes that are sufficiently small that they can appear transparent if they are embedded in a matrix resin with an index of refraction appropriately matched. Ceramic fibers commercially available under the trade designation NEXTEL from 3M Company, St. Paul, Minn., are examples of this type of material, and are available as thread, yarn and woven mats.

Some exemplary arrangements of fibers within the matrix include yarns, tows of fibers or yarns arranged in one direction within the polymer matrix, a fiber weave, a non-woven, chopped fiber, a chopped fiber mat (with random or ordered formats), or combinations of these formats. The chopped fiber mat or nonwoven may be stretched, stressed, or oriented to provide some alignment of the fibers within the nonwoven or chopped fiber mat, rather than having a random arrangement of fibers. Furthermore, the matrix may contain multiple layers of fibers: for example the matrix may include more layers of fibers in different tows, weaves or the like.

Organic fibers may also be embedded within the matrix 104 alone or along with the inorganic fibers. Some suitable organic fibers that may be included in the matrix include polymeric fibers, for example fibers formed of one or more of the polymeric materials listed above. Polymeric fibers may be formed of the same material as the matrix 104, or may be formed of a different polymeric material. Other suitable organic fibers may be formed of natural materials, for example cotton, silk or hemp. Some organic materials, such as polymers, may be optically isotropic or may be optically birefringent.

In some embodiments, the organic fibers may form part of a yarn, tow, weave and the like that contains only polymer fibers, e.g. a polymer fiber weave. In other embodiments, the organic fibers may form part of a yarn, tow, weave and the like that comprises both organic and inorganic fibers. For example, a yarn or a weave may include both inorganic and polymeric fibers. An embodiment of a fiber weave 200 is schematically illustrated in FIG. 2. The weave is formed by warp fibers 202 and weft fibers 204. The warp fibers 202 may be inorganic or organic fibers, and the weft fibers 204 may also be organic or inorganic fibers. Furthermore, the warp fibers 202 and the weft fibers 204 may each include both organic and inorganic fibers. The weave 200 may be a weave of individual fibers, tows, or may be a weave of yarn, or any combination of these.

In many embodiments, the woven fibrous web 200 is formed of glass fibers. In many embodiments, this glass fiber fabric 200 has a yarn count in a range from 25 to 100 yarns per inch along both the x- and y-axis, and a fabric weight in a range from 10 to 100 g/m², and a fabric thickness (z-axis) in a range from 15 to 100 micrometers. In many embodiments, the glass fibers forming each yarn in the glass fiber fabric 200 has a diameter in a range from 5 to 20 micrometers.

A yarn includes a number of fibers strung next to or twisted together. The fibers may run the entire length of the yarn, or the yarn may include staple fiber, where the lengths of individual fibers are shorter than the entire length of the yarn. Any suitable type of yarn may be used, including a conventional twisted yarn formed of fibers twisted about each other. Another embodiment of yarn is characterized by a number of fibers wrapped around a central fiber. The central fiber may be an inorganic fiber or an organic fiber.

In many embodiments, the fibers used to form the fibrous web 200 are below about 250 micrometers in diameter, and may have a diameter down to about 5 micrometers or less. Handling of small polymer fibers individually may be difficult. Using polymeric fibers in a mixed yarn, containing both polymer and inorganic fibers, however, provides for easier handling of the polymeric fibers since the yarn is less prone to being damaged by handling.

Most fibrous webs have two scales associated with inter-fibril separation. In fiberglass fabric, for example, scale of inter-yarn separation is on the order of fractional millimeters, while the scale of inter-fiber separation in a yarn is on the order of micrometers, as described above. In general, resin can be infused into a fibrous web by action of either externally imposed pressure gradient or capillary force. During infusion, air, possibly rarified by applied low pressure, or another gas has to be displaced from inter-yarn and inter-fibril spaces. If during impregnation a number of gas bubbles are entrapped, some of the gas bubbles can be removed by generating a flow of resin through the thickness of the fibrous material. Smaller bubbles can dissolve over time, if the impregnating resin is left to be a liquid for a sufficient time. In fact, sometimes it is desirable to complete the imbibition of the resin into the fabric, and then allow time to elapse for subsequent dissolution of bubbles into the liquid resin. In a manufacturing process, this could be considered as a delay in the time between the introduction of liquid into the fiberglass roll and the processing (unwinding) of that roll and feeding it into the curing process. Entrapped air bubbles can reduce the mechanical and optical properties of a resin impregnated fibrous web. The method employed to contact the resin with the fibrous web can have a significant impact on the size and frequency of the bubbles remaining in the saturated fabric.

The following apparatus and methods have been found to reduce or substantially eliminate entrapped air bubbles or voids. Capillary wicking of the liquid curable resin in the thickness direction (z-axis) of the fibrous web occurs at a rapid rate and results in very few entrapped air bubbles or voids as compared to resin saturation by conventional dipping or dip and nip processes, especially solvent-free processes, in which the resin contacts the dry (unsaturated) fibrous web when it is passed through liquid such that the translation direction of the fibrous web through the liquid is aligned with an x or y direction of the fabric (as illustrated, for example, in FIG. 2). Resin saturation of fiberglass fabric in the current disclosure, thus, obtained by out-of-plane wicking.

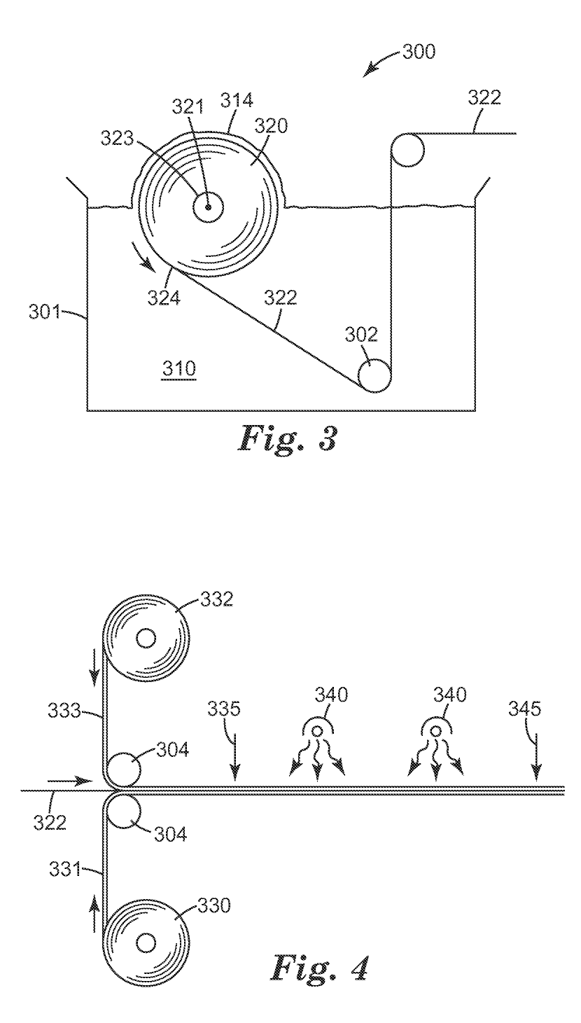

FIG. 3 is a schematic side view of an illustrative apparatus 300 for forming a resin impregnated fibrous web 322. The apparatus 300 includes a volume 310 of liquid curable resin, described above, having a liquid surface 312, and a roll 320 of fibrous web, described above, at least partially submerged in the volume 310 of resin. The apparatus 300 is configured to unwind the roll 320 of fibrous web such that the fibrous web separates, at a separation point 324, from the roll 320 of fibrous web below the liquid surface 312 and forms a resin impregnated fibrous web 322. In many embodiments, the roll 320 of fibrous web includes an upper portion above the liquid surface 312 and a layer 314 of liquid curable resin 310 on the upper portion of the roll 320 of fibrous web as the roll 320 is unwound or rotated. The layer 314 of liquid curable resin can be applied to the outside of the roll 320 either through the natural action of the rotation of the roll, and/or through intentional addition of resin by some mechanism such as a coating device. This coating device could include, but is not limited to, die coating, roll coating, and the like. In the case of FIG. 3, the temperatures of the liquid curable resin and the fibrous web can be manipulated independently (for example, heated or cooled) before they are combined. In many embodiments, the liquid curable resin is solvent-free or 100% solids.

Liquid curable resin saturates, at least, an outer layer of fibrous web through the thickness direction (z-axis) of the fibrous web at a rapid rate and results in very few entrapped air bubbles or voids as compared to resin saturation of the fiberglass by the liquid curable resin (especially in a solvent-less curable resin system) in a dip process, as is commonly used in the industry. In industry, the common dip and nip processes normally involve a solvent-borne curable resin due to otherwise high viscosity and co-reaction of the undiluted reactive components. In addition, separation of the resin impregnated fibrous web 322 below the liquid surface 312 further reduces or substantially eliminates entrapped air bubbles or voids as compared to saturation by the conventional dipping process with idlers, such as a design previously manufactured by Faustel, Inc., (Germantown, Wis.).

The roll of fibrous web 320 is disposed within the volume 310 of liquid curable resin. In many embodiments, the roll of fibrous web 320 is only partially disposed within the volume 310 of liquid curable resin. In some of these embodiments the roll of fibrous web 320 has an axis of rotation 321 above the resin surface 312. In some embodiments, the roll of fibrous web 320 has an axis of rotation 321 below the resin surface 312. In other embodiments, the roll of fibrous web 320 is completely immersed within the volume 310 of liquid curable resin.

In some embodiments, the roll 320 of fibrous web further includes a volume of liquid curable resin within a permeable shaft 323 and the roll 320 of fibrous web is disposed about the permeable shaft 323. In these embodiments, the volume of liquid curable resin within a permeable shaft 323 permeates into the roll 320 of fibrous web and saturates the fibrous web from the inside out. In some embodiments, the roll 320 of fibrous web is saturated with liquid curable resin prior to being placed within the volume 310 of liquid curable resin. In some embodiments, the volume of liquid curable resin within a permeable shaft 323 permeates the roll from the inside out, while the roll is also saturated with a liquid curable resin by previously described methods, or other methods, (from the outside in) simultaneously.

In some embodiments, the roll 320 of fibrous web and/or liquid curable resin is heated. The roll 320 of fibrous web and/or liquid curable resin can be heated to any useful temperature such as, for example, to a temperature range of 25 to 85 degrees centigrade.

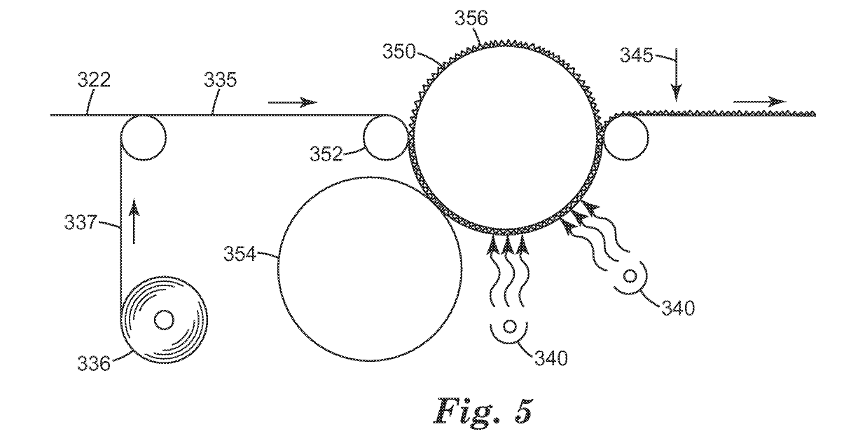

The apparatus 300 further includes a curing station 340 (see FIG. 4 and FIG. 5) positioned to cure the resin impregnated fibrous web 322 and form a cured resin impregnated fibrous web 345. FIG. 4 is a schematic side view of an illustrative apparatus for processing a resin impregnated fibrous web and FIG. 5 is a schematic side view of another illustrative apparatus for processing a resin impregnated fibrous web.

FIG. 4 illustrates the resin impregnated fibrous web 322 disposed between a first backing layer 337 and a second backing layer 339. The backing layers 337, 339 are supplied from backing supply rolls 336, 338 respectively. Rollers 304 assist in laminating the first backing layer 337 and a second backing layer 339 to the resin impregnated fibrous web 322, forming a sandwich of composite resin impregnated fibrous web 335, and backing layers.

The backing layers 337, 339 described herein can be formed of any useful material. In many embodiments, the backing layers 337, 339 are formed of an at least partially visible light transmissive polymer or resin material. In one embodiment, the backing layers 337, 339 are formed of a polyester material. In some embodiments, the backing layers might have a light manipulation function such as light reflection, light polarization, light redirection, a structured surface, and/or a combination of these.

In some embodiments, a coating dispenser 360 provides a liquid coating 361 onto the resin impregnated web 322. This liquid coating 361 can be formed of any useful material such as, for example, an adhesive material, resin materials described herein, and/or the liquid curable resin composition 310. The resin material can be the same or different than the resin material 310 forming the resin impregnated web 322.

In some embodiments of FIG. 5, a roll of fibrous web 320 could be inserted in place of the resin impregnated web 322 and a liquid coating 361 can be applied from a liquid coating source 360. In that case, the curing station 340 could be used to cure the resin to the first cure state while simultaneously producing a surface structure on the composite film. The liquid coating 361 could be the same (or a different) liquid curable resin as 310 in FIG. 3.

In some embodiments, different forms of energy may be applied to the resin impregnated fibrous web 322 including, but not limited to, heat and pressure, UV radiation, electron beam and the like, in order to cure the liquid curable material within the resin impregnated fibrous web 322. In some embodiments, the cured resin impregnated fibrous web 345 is sufficiently supple as to be collected and stored on a take-up roll. In other embodiments, the cured resin impregnated fibrous web 345 may be too rigid for rolling, in which case it is stored some other way, for example the cured resin impregnated fibrous web 345 may be cut into sheets for storage.

As illustrated in FIG. 5, the resin impregnated fibrous web 322 may be molded or shaped prior to curing, or while being cured. For example, the resin impregnated fibrous web 322, and/or a liquid coating or resin layer 361 may be molded to provide a structured surface. The resin impregnated fibrous web 322 combined with a backing layer 337, described above, to form a resin impregnated fibrous web 335 and then guided to a molding roll 350 by a guiding roll 352 and may be pressed against the molding roll 350 by an optional pressure roll 354. The molding roll 350 has a shaped surface 356 that is impressed into the resin impregnated fibrous web 322, and/or a liquid coating or resin layer 361. The spacing between the molding roll 350 and the pressure roll 354 may be adjusted to a set distance that controls the depth of penetration of the shaped surface 356 into the resin impregnated fibrous web 322, and/or a liquid coating or resin layer 361. The resin impregnated fibrous web 322 cured while still in contact with the molding roll 350 by irradiation with UV light or heat from an energy source 340 to form a cured resin impregnated fibrous web 345. As described in relation to FIG. 4, the cured resin impregnated fibrous web 345 may be stored on another roll or cut into sheets for storage. Optionally, the cured resin impregnated fibrous web 345 may be further processed, for example through the addition of one or more layers.

In many embodiments, the curable resin has a controllable viscosity in a range from 10 to 1000 cps, or from 100 to 500 cps and has a surface tension which permits good contact with and wetting of the fibrous web.

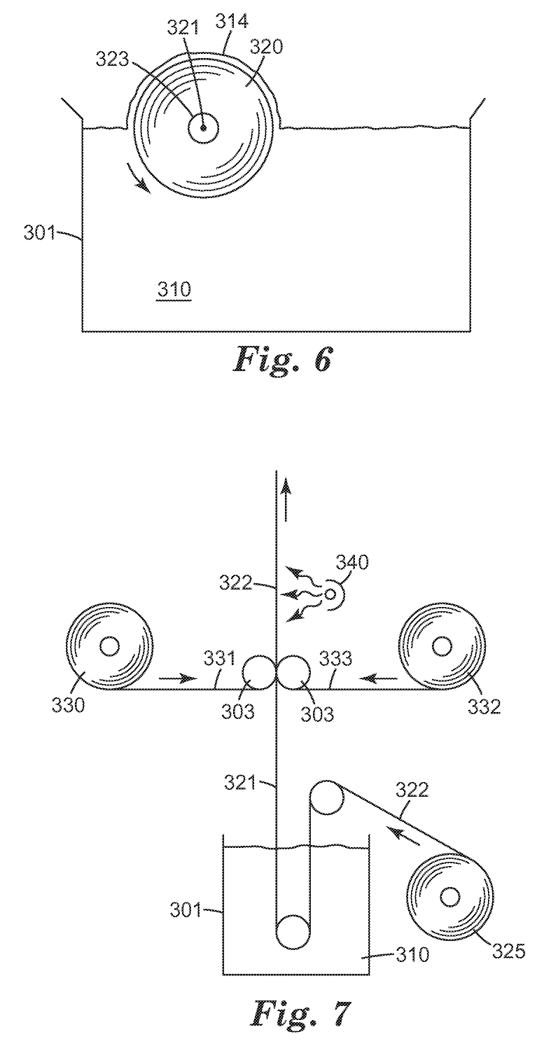

FIG. 6 is a schematic side view of an illustrative apparatus for forming a resin impregnated pre-saturated fibrous web. The apparatus includes a volume 310 of liquid curable resin, described above, having a liquid surface 312, and a roll 320 of fibrous web, described above, at least partially submerged in the volume 310 of resin. The apparatus is configured to rotate the roll 320 of fibrous web such that the liquid curable resin 310 saturates the thickness of the roll 320 and forms a pre-saturated resin impregnated fibrous roll. In many embodiments, the roll 320 of fibrous web includes an upper portion above the liquid surface and a layer 314 of liquid curable resin 310 on the upper portion of the roll 320 of fibrous web as the roll 320 is unwound or rotated. In some embodiments, the roll 320 is completely submerged in the liquid curable resin 310. The layer 314 of liquid curable resin can be applied to the outside of the roll 320 either through the natural action of the rotation of the roll, and/or through intentional addition of resin by some mechanism such as a coating device. This coating device could include, but is not limited to, die coating, roll coating, and the like. In the case of FIG. 6, the temperatures of the liquid curable resin and the fibrous web can be manipulated independently (for example, heated or cooled) before they are combined. In many embodiments, the liquid curable resin is solvent-free or 100% solids.

In some embodiments, the roll 320 of fibrous web can be pre-saturated with (alone or in addition to the bath of liquid curable resin 310) a volume of liquid curable resin within a permeable shaft 323 and the roll 320 of fibrous web is disposed about the permeable shaft 323. In these embodiments, the volume of liquid curable resin within a permeable shaft 323 permeates into the roll 320 of fibrous web and pre-saturates the fibrous web from the inside out. In some embodiments, the volume of liquid curable resin within a permeable shaft 323 permeates the roll from the inside out, while the roll is also saturated with a liquid curable resin by previously described methods, or other methods, (from the outside in) simultaneously.

Liquid curable resin saturates the roll of fibrous web through the thickness direction (z-axis) of the fibrous web at a rapid rate and results in very few entrapped air bubbles or voids as compared to resin saturation of the fiberglass by the liquid curable resin (especially in a solvent-less curable resin system) in a dip process, as is commonly used in the industry. In industry, the common dip and nip processes normally involve a solvent-borne curable resin due to otherwise high viscosity and co-reaction of the undiluted reactive components. The pre-saturated roll of fibrous web can then be utilized as the fibrous web supply roll 320 described above and shown in FIG. 3. In some embodiments, the pre-saturated roll of fibrous web can be utilized directly as the saturated fibrous web 322 as described above and as shown in FIG. 4 and FIG. 5.

In other embodiments, as shown in FIG. 7, the pre-saturated roll of fibrous web 325 can be utilized in a conventional un-wind and dip process where apparatus includes a volume 310 of liquid curable resin, described above, and a pre-saturated roll 325 of fibrous web, described above, provides a layer of resin saturated fibrous web 322 to the volume 310 of resin, forming a resin impregnated fibrous web or composite film 321. The resin impregnated fibrous web or composite film 321 proceeds through nip rollers 303 and then is exposed to a energy source or curing station 340 to cure the composite film.

In many embodiments, one or more films 331, 333 are laminated (as described above) onto one or both major surfaces of the composite film 322 as it proceeds through nip rollers 303 and then is exposed to a energy source or curing station 340 to cure the composite film. The films 331, 333 can be any useful film such as a polymeric backing film or an optical film. The films 331, 333 can be provided by film rolls 330, 332. In some embodiments, the film 331, 333 is a light control film for glare and reflection management, as described above.

In still other embodiments, the pre-saturated roll of fibrous web 325 can be used as shown in FIG. 7 except the absence of the conventional dip process. In these embodiments, a volume 310 of liquid curable resin is not present and the resin saturated fibrous web 322 is directly used in the further processing methods illustrated in FIG. 4 and FIG. 5 above.

Gas bubble area measurement is now described. A resin impregnated fibrous web sample was mounted on the Olympus SZX12 microscope outfitted with 1.6× lens. Images were captured with Olympus DP70 interfaced with Image-Pro v.5 software. Images were analyzed with same software. The procedure for measuring bubbles is similar to the procedure described in Ph.D. Thesis by Anant Mahale (Characterization of voids formed during liquid impregnation of non-woven multifilament glass networks as related to composite manufacture, Princeton University, 1994 available from University Microfilms International, 300 North Zeeb Rd, Ann Arbor, Mich. 48106, USA) with one important difference: in our measurements the smallest measurable round air pocket has an area of 7.8 10⁻⁷ cm² compared to 0.0001 cm² in the abovementioned thesis. Our procedure was as follows. With 1.6× lens on lowest zoom magnification and with a ringlight adjusted to give an even lighting over the area of view, which was 5.2 mm in width, images were captured at full resolution into Image-Pro v.5. Captured images were then converted into the grey scale, and the histogram was adjusted so that round bubbles with a diameter as small as 5 micrometers and elongated bubbles with smallest dimension of down to 5 micrometers became of a uniform color. The total area of these bubbles was than calculated by Image-Pro and divided by a total area of the area of the view. The total area fraction reported by the Image Pro software was converted into an area percent and is reported in the examples.

Utilizing the methods and apparatus described herein, gas bubble area measurements of 1% or less, or 0.05% or less, are possible.

The film constructions described above and in the examples below, containing the saturated fiberglass was exposed to an array of LEDs emitting UV light (for the purpose of curing the resin). The UVLEDs were purchased from Nichia (Tokyo, Japan) and mounted into an array of 4 rows by 40 columns of LEDs. The spectral output for these LEDs peaked around 385 nm with a narrow spectral distribution from approximately 365 nm to 410 nm. The LED array was supplied with 39 Volts of power to supply 7.34 Amps of current through the LEDs. The UV light penetrated the PET films and cured the polymerizable resin within and around the fiberglass fabric. After curing the polymerizable resin, the saturated fiberglass web path through the coater caused the saturated web (and PET liners) to pass under a UV arc lamp system purchased from Fusion Aetek (Part number 19031D, Romeoville, Ill.). The UV arc lamp system was used with one arc lamp illuminating the web, and it was set to the low power setting.

The radiometric measurements were completed on the Arc lamp with a Power Puck that had recently been calibrated (EIT Inc., Sterling, Va.), at a linespeed of 6.096 meters/min and the dose was subsequently calculated for the 5 meters per minute process speed (and reported in Table 1). Radiometric measurements for the UVLEDs were completed with an IL 1700 Research Radiometer (International Light, Peabody, Mass.) with SED005 detector and a “W” diffuser, with the 380-nm calibration factor. For the Example(s), the UVLEDs (powered at 7.34 Amps) delivered an equivalent UVA light dose of 34.9 mJ/cm².

TABLE 1
UV Dose Measurements for the Fusion Aetek arc lamp (one lamp, low
power setting), line speed = 5 meters/min for calculated dose

| | Dose | Intensity |
|---|---|---|
| | (mJ/cm\hat{ }2) | mW/cm\hat{ }2 |
| UVA | 384 | 561 |
| UVB | 323 | 470 |
| UVC | 44 | 68 |
| UVV | 217 | 532 |

### EXAMPLES

### Example 1

### Non-Submerged Unwind, Non-Pre-Saturated, Comparative

Experiments were performed on a modified Hirano 200L coater. A roll of fiberglass material was mounted outside the tank that contained a UV-curable acrylate mixture of the following composition: 74.81 weight % of SR601 from Sartomer Company (Exton, Pa.), 0.25 weight % TPO from BASF Corporation (Charlotte, N.C.), 12.47 weight % SR247 from Sartomer Company, and 12.47 weight % TO-1463 from Toagosei America (West Jefferson, Ohio). The tank was mounted on a linear stage that allowed up-and-down movement of the tank. The curable acrylate mixture was maintained at a temperature of 33 degrees centigrade in the tank using an external tank heater. A 12-inch-wide fiberglass material (Style number 106 with 627 finish from BGF Industries, Greensboro, N.C.) was mounted outside the tank on the unwinder of the coater and threaded around an idler roller that was above the level of the acrylate when the tank was in the “down” position and then the fiberglass path continued into other sections of the coater. When the tank was in the “up” position, the idler became submerged and the fiberglass fabric also became submerged. After being saturated in the tank, the resin saturated fiberglass was then sandwiched between two layers of PET film with the unprimed side in contact with the resin-rich fiberglass fabric (Dupont Melinex® 618 PET film, Dupont Teijin Films US Limited Partnership, Hopewell, Va.) in a pressure-controlled nip between a steel roll and a rubber-covered roll. The three-layer construction of PET-fiberglass-PET was then threaded through a UV-light source (manufactured by Fusion Aetek, Part number 19031 D, Romeoville, Ill.) and into the winding section of the coater. The total length of fiberglass submerged inside the tank was approximately 2 feet. The line was then run at a speed of 5 m/min, with pressure in the nip air cylinders of 2 kgf/cm², with a single-bulb in the above-described UV-curing apparatus with low power setting, and UV-LED curing (system described above, with current of 7.34 Amps). Samples were collected after the exposure to both UV-light sources, when the resin matrix had become solid. Both layers of PET were removed and the remaining composite film was analyzed for bubble content under the microscope. The thickness of the composite sample was 1.3 mils as measured by the caliper gauge. The area percent of bubbles, as measured via the microscope procedure described previously, in the resulting sample was 2.20%.

### Example 2

### Submerged Unwind, Non-Pre-Saturated

Experiments were performed on a modified Hirano 200L coater. A roll of fiberglass material was mounted on the sides of the tank that contained UV-curable acrylate of the same composition as identified in Example 1. When mounted, the bottom portion of the roll of fiberglass material was submerged in the acrylate. The tank was mounted on a linear stage that allowed up-and-down movement of the tank. A 12-inch-wide fiberglass material (Style number 106 with 627 finish from BGF Industries, Greensboro, N.C.) was wrapped around an idler roller that was above the level of the acrylate when the tank was in the down position. When the tank was in the “up” position, the idler became submerged and the fiberglass fabric also became submerged. The temperature of the curable acrylate mixture in the tank was maintained at 31 degrees centigrade with an external tank heater. After being saturated in the tank, the resin saturated fiberglass was then sandwiched between two layers of PET film with the unprimed side in contact with the resin-rich fiberglass fabric (Dupont Melinex® 618 PET film, Dupont Teijin Films US Limited Partnership, Hopewell, Va.) in a pressure-controlled nip between a steel roll and a rubber-covered roll. The three-layer construction of PET-fiberglass-PET was then threaded through a UV-light source (manufactured by Fusion Aetek, Part number 19031D, Romeoville, Ill.) and into the winding section of the coater. At the beginning of the experiment the acrylate-containing tank was raised to the up position. In that position the idler became submerged. The total length of fiberglass inside the tank was around 2 feet. The line was then run at a speed of 5 m/min, the pressure in the nip air cylinders was 2 kgf/cm² and with a single-bulb in the above-described UV-arc-lamp-curing apparatus with low power setting, and with UVLED curing also (system described above, with current of 7.34 Amps). Resulting polymerized material was wound onto a core, with sample positions marked, and later samples were extracted every 2.5 meters at the marks. The total length of wound web was 20 meters. Both layers of PET were removed from the samples and the remaining composite film was analyzed for bubble content under the microscope. The thickness of the samples was measured by the caliper gauge. The table below reports caliper of the samples and the bubble area percent measured. The sample positions are indicated as distance from the outside end of the roll. For example, the “0” position sample was the first sample taken as the saturated roll was unwound and sent through the UV-curing operation. The sample with the highest distance from the end of the roll was initially in the position closest to the core of the roll of fiberglass used in the experiment.

| Distance | | |
|---|---|---|
| from end | | |
| of roll | Caliper | Bubble area |
| (meters) | (mils) | measured (%) |
| 0 | 1.4 | 0.037 |
| 2.5 | | 0.043 |
| 5 | 1.4 | 0.050 |
| 7.5 | | 0.025 |
| 10 | 1.3 | 0.018 |
| 12.5 | 1.3 | 0.007 |
| 15 | 1.3 | 0.084 |
| 17.5 | 1.3 | 0.016 |
| 20 | 1.3 | 0.021 |

Thus, embodiments of the APPARATUS AND METHOD OF IMPREGNATING FIBROUS WEBS are disclosed. One skilled in the art will appreciate that the present disclosure can be practiced with embodiments other than those disclosed. The disclosed embodiments are presented for purposes of illustration and not limitation, and the present invention is limited only by the claims that follow.

1. An apparatus, comprising:
a volume of liquid curable resin having a liquid surface; and
a liquid curable resin saturated roll of fibrous web at least partially submerged in the volume of resin, the apparatus configured to unwind the roll of fibrous web such that the fibrous web separates from the roll of fibrous web below the liquid surface and forms a resin impregnated fibrous web.

2. An apparatus according to claim 1, wherein the liquid curable resin saturated roll of fibrous web comprises an upper portion above the liquid surface and a layer of liquid curable resin is on the upper portion of the roll of fibrous web as the roll is unwound.

3. An apparatus according to claim 1, wherein the fibrous web is a woven glass fibrous web.

4. An apparatus according to claim 1, wherein the liquid curable resin saturated roll of fibrous web has an axis of rotation above the resin surface.

5. An apparatus according to claim 2, wherein the layer of liquid curable resin saturates an outer layer of fibrous web on the liquid curable resin saturated roll of fibrous web.

6. An apparatus according to claim 1, wherein the liquid curable resin saturated roll of fibrous web further comprises a volume of liquid curable resin within a permeable shaft and the liquid curable resin saturated roll of fibrous web is disposed about the permeable shaft.

7. An apparatus according to claim 1, further comprising a curing station positioned to cure the resin impregnated fibrous web and form a cured resin impregnated fibrous web.

8. An apparatus according to claim 7, wherein the cured resin impregnated fibrous web is at least partially transparent to at least one polarization of visible light.

9. An apparatus according to claim 1, wherein the resin is solvent free.

10. A method of impregnating a fibrous web, comprising:
disposing a liquid curable resin saturated roll of fibrous web at least partially in a volume of liquid curable resin and having a liquid surface;
unwinding the liquid curable resin saturated roll of fibrous web such that the fibrous web separates from the liquid curable resin saturated roll of fibrous web below the liquid surface and forms a resin impregnated fibrous web; and
curing the resin impregnated fibrous web to form a cured resin impregnated fibrous web.

11. A method according to claim 10, further comprising laminating the resin impregnated fibrous web to an at least partially visible light transmitting polymer film and curing the resin impregnated fibrous web to form a cured impregnated fibrous composite.

12. A method according to claim 10, further comprising curing the resin impregnated fibrous web while the resin impregnated fibrous web is in contact with a structured surface to form a cured impregnated fibrous composite.

13. A method according to claim 10, wherein the cured resin impregnated fibrous web has a void volume 1% or less.

14. A method according to claim 10, further comprising heating the roll of fibrous web.

15. A method according to claim 10, wherein the liquid curable resin saturated roll of fibrous web has an axis of rotation above the liquid surface.

16. A method according to claim 10, wherein the liquid curable resin is solvent free.
